(19) United States
(12) Patent Application Publication
(10) Pub. No.: US 2007/0204446 A1
(43) Pub. Date: Sep. 6, 2007

(54) Method for Manufacturing Solid Electrolytic Capacitor

(75) Inventor: Chojiro Kuriyama, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 11/547,326

(22) PCT Filed: Apr. 4, 2005
(86) PCT No.: PCT/JP05/06597

§ 371 Date: Oct. 3, 2006

(30) Foreign Application Priority Data
Apr. 5, 2004 (JP) 2004-111101

(51) Int. Cl. H01G 9/00

(52) U.S. Cl. 29/25.03; 361/523

(57) ABSTRACT

A solid -electrolytic capacitor manufacturing method according to the present invention includes a dielectric layer formation step for forming a dielectric layer at an inner surface and an outer surface of a porous sintered body (1) to which an anode bar (2A, 2B) including a projecting portion (2a, 2b) is mounted, a solid electrolytic layer formation step for forming a solid electrolytic layer (30) on the dielectric layer, a covering step for covering at least part of the projecting portion of the anode bar (2A, 2B) by a covering member (41a, 41b) before the solid electrolytic layer formation step, and a removal step for removing at least part of the covering member (41a, 41b) after the solid electrolytic layer formation step.

### TECHNICAL FIELD

The present invention relates to a method for manufacturing a solid electrolytic capacitor which includes a porous sintered body and an and bar fixed to the sintered body.

### BACKGROUND ART

In the technical field of a capacitor, a solid electrolytic capacitor is known which includes a porous sintered body of a so-called valve metal (a metal which is capable of exhibiting valve action with respect to passing of current under certain structural conditions) and an anode bar fixed to the porous sintered body to project from the porous sintered body.

FIG. 18 shows a conventional intermediate product prepared in a process of manufacturing such a solid electrolytic capacitor. The intermediate product includes a porous sintered body 91, an anode bar 92 fixed to the porous sintered body 91 and a ring 93 fitted around the anode bar 92. The porous sintered body 91 and the anode bar 92 are made of valve metal. The anode bar 92 includes a projecting portion 92a projecting out from the porous sintered body 91. The ring 93 is made of a highly water-repellent resin. To prepare the intermediate product, the porous sintered body 91 is first formed by compacting and sintering a predetermined amount of valve metal powder with part of the anode bar 92 inserted therein. Then, the ring 93 is fitted around the projecting portion 92a of the anode bar 92 so that the ring 93 comes into contact with the porous sintered body 91.

In a conventional solid electrolytic layer manufacturing method which utilizes the intermediate product shown in FIG. 18, a dielectric layer (not shown) is first formed at a anodizing process. Specifically, the porous sintered body 91 is entirely immersed in a predetermined treatment liquid for forming a dielectric layer (e.g. an aqueous solution of phosphoric acid), with part of the projecting portion 92a of the anode bar 2 kept out of the treatment liquid. In this process, the intermediate product is held at such a height that the level of the treatment liquid is spaced above the ring 93 by at least several millimeters. Subsequently, a predetermined electric potential is applied to an electrode arranged in the treatment liquid, while a predetermined electric potential is applied to the anode bar 92 and the porous sintered body 91 via the part of the projecting portion 92a which is not immersed in the treatment liquid, so that direct current flows through the porous sintered body 91 and the anode bar 92. By this anodizing process, a dielectric layer (not shown) comprising an oxide film of valve metal is formed at an inner and an outer surfaces of the porous sintered body which is entirely immersed in the treatment liquid and a surface of the anode bar 92 which is in contact with the treatment liquid. In this process, since the intermediate product is held at such a height that the level of the treatment liquid is above the ring 93, the dielectric layer is formed at a part of the projecting portion 92a which comes into contact with the treatment liquid at a position above the ring 93.

Subsequently, in the conventional solid electrolytic layer manufacturing method, a solid electrolytic layer is formed on the dielectric layer formed in the above-described manner. Specifically, as shown in FIG. 19, the porous sintered body 91 is immersed in a treatment liquid 97 for forming a solid electrolytic layer (e.g. an aqueous solution of manganese nitrate). In this process, the intermediate product is held at such a height that the level 97a of the treatment liquid 97 does not come over the ring 93. Specifically, the height of the intermediate product is controlled within a predetermined height range (several hundred microns) so that the level 97a of the treatment liquid 97 comes over the shoulder of the porous sintered body 91 but does not come over the ring 93. After the immersion, the intermediate product is subjected to baking. By repetitively performing the immersion process and the subsequent baking process a plurality of times, a solid electrolytic layer (not shown) of e.g. manganese dioxide is formed on the above-described dielectric layer.

Thereafter, a solid electrolytic capacitor Y is completed by making other parts, as shown in FIG. 20, for example. In the solid electrolytic capacitor Y, a conductive film 94 made up of e.g. a graphite layer and a silver layer is formed on a predetermined portion of the solid electrolytic layer on the porous sintered body 91. Terminals 95a and 95b are connected to the anode bar 92 and the conductive film 94, respectively, and a sealing resin member 96 is provided. The solid electrolytic capacitor manufacturing method described above is disclosed in Patent Document 1, for example.

Patent Document 1: JP-A-2004-47640

In the solid electrolytic layer formation step described above with reference to FIG. 19, it is necessary to prevent a solid electrolytic layer from being formed on a portion of the anode bar 92 on which the dielectric layer is not formed. This is because, when the anode bar 92 and the solid electrolytic layer come into direct contact with each other without the intervention of the dielectric layer, the terminals 95a and 95b of the solid electrolytic capacitor Y are electrically connected to each other without the intervention of the dielectric layer, which deteriorates a so-called capacitor function (such as the storage function) of the solid electrolytic capacitor Y. Therefore, in the solid electrolytic layer formation step, the intermediate product is held at such a height that the level 97a of the treatment liquid 97 does not come over the ring 93, whereby the treatment liquid 97 is prevented from coming close to or into contact with a part of the projecting portion 92a of the anode bar 92 which is above the ring 93 (made of highly water repellent resin). Even in the case where the dielectric layer is formed up to a certain part of the projecting portion 92a which is positioned higher than the ring 93 by a predetermined distance in the above-described dielectric layer formation step, when the level 97a of the treatment liquid 97 comes over the ring 93 in the solid electrolytic layer formation step, the treatment liquid 97 may reach a part of the anode bar 92 where the dielectric layer is not formed due to the surface tension. However, by preventing the treatment liquid 97 from coming close to or into contact with a part of the projecting portion 92 which is above the ring 93, the formation of the solid electrolytic layer on a portion where the dielectric layer is not formed is properly avoided.

A swill be understood from FIG. 20, in the solid electrolytic capacitor Y, the terminal 95a cannot be bonded to a portion of the anode bar 92 or the projecting portion 92a which is covered by the ring 93. Therefore, as the thickness of the ring 93 increases, i.e., as the length of the ring 93 in the direction in which the anode bar 92 extends increases, the size of the solid electrolytic capacitor Y tends to increase. To respond to the recent demand for the size reduction of a solid electrolytic capacitor, it is preferable that the ring 93 is thin. However, the thinner the ring 93 is, the more difficult it is to hold the intermediate product or the porous sintered body 91 at such a height that the level 97a does not come over the ring 93 in the solid electrolytic layer formation process described with reference to FIG. 19. Therefore, in the prior art technique, the ring 93 needs to have a significant thickness so that the size of the solid electrolytic capacitor Y cannot be sufficiently reduced.

### DISCLOSURE OF THE INVENTION

The present invention is conceived under the above-described circumstances, and it is an object of the present invention to provide a solid electrolytic capacitor manufacturing method which is capable of reducing the size of a solid electrolytic capacitor while preventing the anode bar and the solid electrolytic layer from unduly coming into contact According to the present invention, there is provided a method for manufacturing a solid electrolytic capacitor. The method comprises a dielectric layer formation step for forming a dielectric layer at an inner surface and an outer surface of a porous sintered body to which an anode bar is fixed, the anode bar including a projecting portion projecting from the porous sintered body, a solid electrolytic layer formation step for forming a solid electrolytic layer on the dielectric layer, a covering step for covering at least part of the projecting portion of the anode bar by a covering member, the covering step being performed before the solid electrolytic layer formation step, and a removal step for removing at least part of the covering member, the removal step being performed after the solid electrolytic layer formation step. As a technique for forming a dielectric layer in the dielectric layer formation step, anodizing may be employed which is performed with a portion at which the dielectric layer is to be formed immersed in a predetermined treatment liquid. As a technique for forming a solid electrolytic layer in the solid electrolytic layer formation step, immersing of a portion to which a solid electrolytic layer is to be formed in a predetermined treatment liquid and subsequent baking may be performed a plurality of times. In the covering step, for example, a covering member is formed circumferentially around a predetermined part of a projecting portion of the anode bar.

In this method, the position of an end of the dielectric layer on the projecting portion is set appropriately in the dielectric layer formation step, while the position of the covering member on the projecting portion is set appropriately in the covering step. By this setting, after both of the dielectric layer formation step and the covering step, the end of the dielectric layer on the projecting portion is positioned farther from the porous sintered body than the end of the glass tube which is closer to the porous sintered body. That is, the obverse surface of a portion of the anode bar between the porous sintered body and the glass tube can be prevented from being exposed in the solid electrolytic layer formation step. Further, in this method, part of the projecting portion of the anode bar is covered by the covering member before the solid electrolytic layer formation step, and this part does not come into contact with the solid electrolytic layer formed in the solid electrolytic layer formation step. Moreover, in this method, the covering member may be fixed, in the covering step, to the projecting portion so as not to cover an end of the projecting portion, and the solid electrolytic layer may be formed, in the solid electrolytic layer formation step, also on the end of the projecting portion (in this case, the anode bar and the solid electrolytic layer come into direct contact with each other at the end). In this case, the end of the projecting portion of the anode bar can be removed by cutting the anode bar at a portion covered by the covering member after the solid electrolytic layer formation step. Therefore, this method is suitable for preventing undesirable contact between the anode bar and the solid electrolytic layer in the obtained solid electrolytic capacitor.

Since at least part of the covering member is removed in the removal step in this method, the anode bar can have a sufficient area for connection to a terminal. Therefore, this method is suitable for reducing the size of a solid electrolytic capacitor.

In this way, the method according to the present invention is suitable for reducing the size of a solid electrolytic capacitor while preventing the anode bar and the solid electrolytic layer from unduly coming into contact with each other.

In a preferred embodiment, -the covering step is performed before the dielectric layer formation step. With this arrangement, it is not necessary to work the porous sintered body and the anode bar or to mount a member to these elements between the dielectric layer formation step and the solid electrolytic layer formation step. Therefore, with this arrangement, the dielectric layer formation step and the solid electrolytic layer formation step can be per formed efficiently.

In another preferred embodiment, the covering step is performed after the dielectric layer formation step. With this arrangement, in the dielectric layer formation step, the dielectric layer can be formed reliably also on a surface portion of the anode bar (projecting portion) which is to be covered by the covering member in the covering step. Therefore, this arrangement is suitable for preventing the anode bar (projecting portion) and the solid electrolytic layer from unduly coming into contact with each other.

Preferably, the method further comprises the step of cutting the anode bar at a position spaced from the porous sintered body, and the cutting step is performed after the solid electrolytic layer formation step. With this arrangement, the process steps before the cutting step can be performed using an anode bar longer than necessary as the structural part of a solid electrolytic capacitor, so that the processing target (intermediate product) can be handled easily in the process steps before the cutting step.

Preferably, the method further comprises the step of cutting the anode bar at a position covered by the covering member, and the cutting step is performed after the solid electrolytic layer formation step. As noted before, the covering member may be fixed, in the covering step, to the projecting portion so as not to cover an end of the projecting portion, and the solid electrolytic layer may be formed, in the solid electrolytic layer formation step, also on the end of the projecting portion. In this case, the end of the projecting portion of the anode bar can be removed by cutting the anode bar at a position covered with the covering member. Therefore, this arrangement may be suitable for preventing undesirable contact between the anode bar and the solid electrolytic layer in the manufactured solid electrolytic capacitor.

Preferably, an additional anode bar is fixed to the porous sintered body, and the additional anode bar includes a projecting portion projecting from the porous sintered body. The dielectric layer formation step may comprise immersing the projecting portion of the additional anode bar entirely in a treatment liquid for forming the dielectric layer. The covering step may comprise covering at least part of the projecting portion of the additional anode bar by an additional covering member. The solid electrolytic layer formation step may comprise immersing the projecting portion of the additional anode bar entirely in a treatment liquid for forming the solid electrolytic layer. The removal step may comprise removing at least part of the additional covering member.

When this arrangement is employed, similarly to the above-described anode bar, the additional anode bar is also prevented from unduly coming into contact with the solid electrolytic layer in the manufactured solid electrolytic capacitor. Therefore, according to this arrangement, a solid electrolytic capacitor including a plurality of anode bars fixed to a porous sintered body can be manufactured properly. In a solid electrolytic capacitor including a plurality of anode bars fixed to a porous sintered body, it is possible to flow current dispersedly through the plurality of anode bars, which is advantageous for reducing the resistance and the inductance.

Preferably, in a state in which the covering member covers the anode bar, the covering member has a cylindrical configuration extending in a direction in which the anode bar extends. The longer the covering member is in the anode bar extending direction, the larger the allowable range of the height of the intermediate product is relative to the level of the treatment liquid in the solid electrolytic layer formation step.

Preferably, the covering member comprises a glass tube, and the covering step comprises fitting the glass tube around the anode bar. Since a glass tube is excellent in acid resistance and corrosion resistance, this arrangement is suitable for preventing the covering member from corroding to unduly expose the anode bar in the dielectric layer formation step and the solid electrolytic layer formation step.

Preferably, the covering member comprises a metal wire, and the covering step comprises winding the metal wire around the anode bar. When a metal wire is employed as the covering member, the metal wire is removed in the removal step by pulling off the metal wire while holding one end thereof.

Preferably, the covering member comprises a linear member made of resin, and the covering step comprises winding the linear member around the anode bar. When the linear resin member is employed as the covering member, the linear resin member is removed in the removal step by pulling off the linear resin member while holding one end thereof.

Preferably, the covering step comprises bonding the covering member to the anode bar with a bonding material. This arrangement is suitable for preventing the treatment liquid for forming the solid electrolytic layer from entering a region between the covering member and the anode bar in the solid electrolytic capacitor formation step.

Preferably, the covering member comprises a tubular member made of resin having a heat shrinkability, and the covering step comprises fitting the tubular member around the anode bar. With this arrangement, by heating the tubular resin member after the covering step, the tubular member can be brought into close contact with the anode bar. Therefore, this arrangement is suitable for preventing the treatment liquid for forming the solid electrolytic layer from unduly entering a region between the covering member and the anode bar in the solid electrolytic capacitor formation step.

### BRIEF DESCRIPTION OF THE DRAWINGS

FIG. 1 shows a part of process step of a solid electrolytic capacitor manufacturing method according to the present invention.

FIG. 2 shows a part of process step (part of a covering step) of a solid electrolytic capacitor manufacturing method according to the present invention.

FIG. 3 shows a part of process step (part of the covering step) of a solid electrolytic capacitor manufacturing method according to the present invention.

FIG. 4 shows a part of process step (part of a dielectric layer formation step) of a solid electrolytic capacitor manufacturing method according to the present invention.

FIG. 5 shows a part of process step (part of a solid electrolytic layer formation step) of a solid electrolytic capacitor manufacturing method according to the present invention.

FIG. 6 shows a part of process step (part of the solid electrolytic layer formation step) of a solid electrolytic capacitor manufacturing method according to the present invention.

FIG. 7 shows a part of process step (part of a cutting step) of a solid electrolytic capacitor manufacturing method according to the present invention.

FIG. 8 shows a part of process step (part of a removal step) of a solid electrolytic capacitor manufacturing method according to the present invention.

FIG. 9 shows a solid electrolytic capacitor which can be formed by a solid electrolytic capacitor manufacturing method according to the present invention.

FIG. 10 shows a variation of the covering step.

FIG. 11 shows another variation of the covering step.

FIG. 12 shows another variation of the covering step.

FIG. 13 shows another variation of the covering step.

FIG. 14 shows the mode of a connection portion of an anode bar to a porous sintered body when the covering step shown in FIG. 13 is employed.

FIG. 15 shows another variation of the covering step.

FIG. 16 shows the mode of a connection portion of an anode bar to a porous sintered body when the covering step shown in FIG. 15 is employed.

FIG. 17 shows another variation of the covering step.

FIG. 18 is a sectional view showing an intermediate product prepared by a conventional solid electrolytic capacitor manufacturing method.

FIG. 19 shows an immersion process performed in a solid electrolytic capacitor formation step of a conventional solid electrolytic capacitor manufacturing method.

FIG. 20 is a sectional view showing an example of solid electrolytic capacitor manufactured by the conventional solid electrolytic capacitor manufacturing method.

### BEST MODE FOR CARRYING OUT THE INVENTION

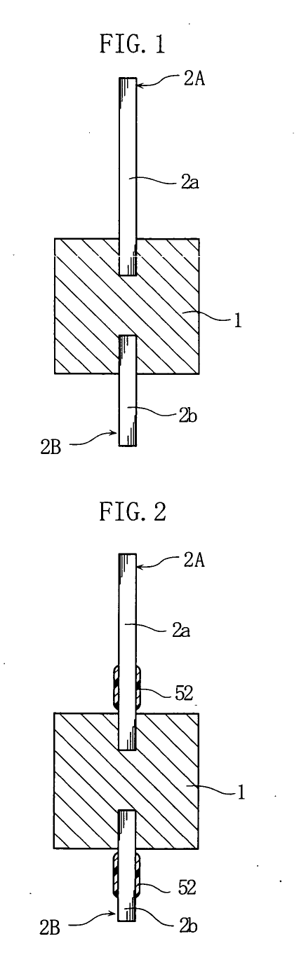

FIGS. 1-8 show a solid electrolytic capacitor manufacturing method according to the present invention. In this manufacturing method, an intermediate product as shown in FIG. 1 is first prepared. The intermediate product includes a porous sintered body 1, and anode bars 2A and 2B fixed to the porous sintered body 1. The porous sintered body 1 and the anode bars 2A and 2B are made of a so-called valve metal. In this embodiment, niobium is used as the valve metal. The anode bars 2A and 2B include projecting portions 2a and 2b, respectively, which project out of the porous sintered body 1. The anode bar 2A is longer than the anode bar 2B. To prepare the intermediate product, niobium powder is loaded into a mold, and each of the anode bars 2A and 2B is partially inserted into the powder. In this state, the powder is compacted and then sintered.

Subsequently, as shown in FIG. 2, bonding resin 52 is applied to predetermined portions of the projecting portions 2a and 2b of the anode bars 2A and 2B. The bonding resin 52 corresponds to a bonding material in the present invention.

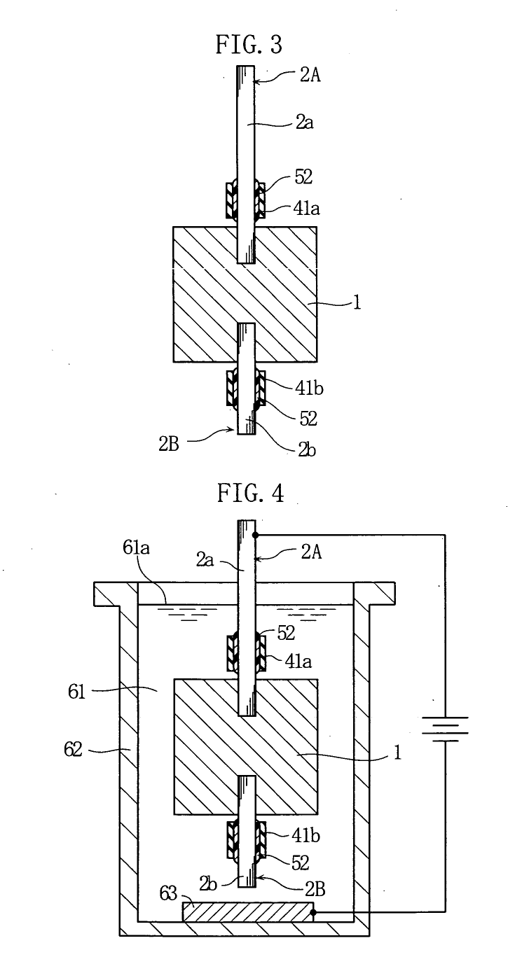

Then, as shown in FIG. 3, a glass tube 41a having an inner diameter larger than the outer diameter of the anode bar 2A is fitted around the projecting portion 2a and bonded to the projecting portion 2a with the bonding resin 52, while a glass tube 41b having an inner diameter larger than the outer diameter of the anode bar 2B is fitted around the projecting portion 2b and bonded to the projecting portion 2b with the bonding resin 52. The glass tubes 41a and 41b correspond to a covering member in the present invention. The length of the glass tube 41a, 41b is so set that an external connection member can be properly connected to the anode bar 2A, 2B in a solid electrolytic capacitor to be manufactured by this manufacturing method. It is to be noted that, in the process step shown in FIG. 2, the bonding resin 52 of the amount sufficient to completely fill the gap between the glass tube 41a, 41b and the projecting portion 2a, 2b is applied.

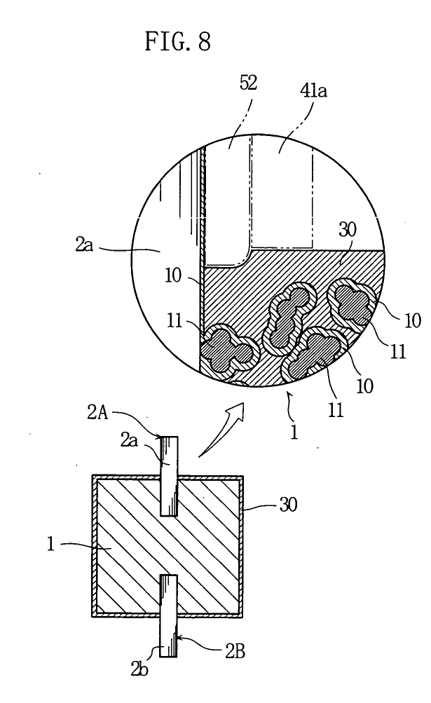

Subsequently, by the anodizing process as shown in FIG. 4, a dielectric layer (not shown, except for FIG. 8) is formed at a predetermined portion of the intermediate product. Specifically, in the anodizing process shown in FIG. 4, the porous sintered body 1 and the anode bar 2B are immersed in a treatment liquid 61 for forming a dielectric layer (an aqueous solution of phosphoric acid in this embodiment) which is prepared in advance in a container 62, while keeping part of the projecting portion 2a of the anode bar 2A out of the treatment liquid 61. In this process, the intermediate product is held at such a height that the level 61a of the treatment liquid 61 is spaced above the glass tube 41a by a predetermined distance. After the inside of the porous sintered body 1 is sufficiently impregnated with the treatment liquid 61, a predetermined electric potential is applied to an electrode 63 arranged in the treatment liquid 61, while a predetermined electric potential is applied to the anode bar 2A, the porous sintered body 1 and the anode bar 2B via the part of the projecting portion 2a which is not immersed in the treatment liquid 61. As a result, direct current flows through the porous sintered body 1 and the anode bars 2A and 2B. By this anodizing process, a dielectric layer of niobium pentoxide is formed at an inner and an outer surfaces of the porous sintered body 1 and surfaces of the anode bars 2A and 2B which are in contact with the treatment liquid 61.

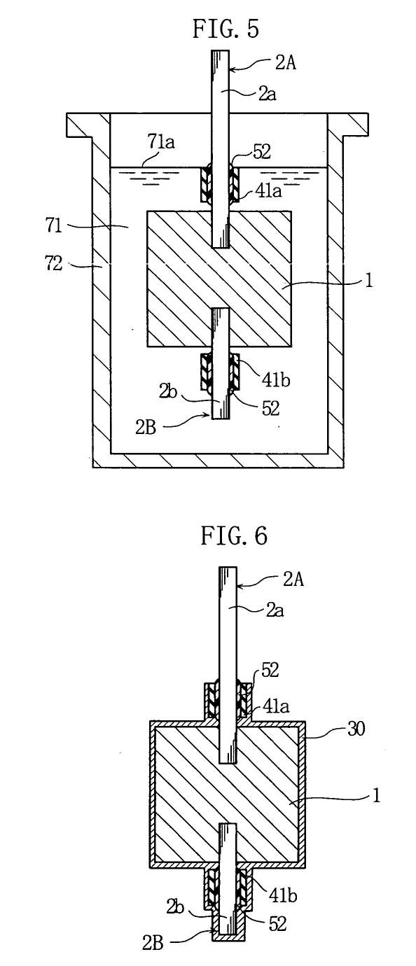

Subsequently, a solid electrolytic layer is formed at a predetermined portion of the intermediate product. Specifically, as shown in FIG. 5, the porous sintered body 1 and the anode bar 2B are immersed in a treatment liquid 71 for forming a solid electrolytic layer (an aqueous solution of manganese nitrate in this embodiment) prepared in advance in a container 72, while keeping part of the projecting portion 2a of the anode bar 2A out of the treatment liquid 71. In this process of this embodiment, the intermediate product is held at such a height that the level 71a of the treatment liquid 71 does not come over the glass tube 41a. To properly form a solid electrolytic layer at an inner and an outer surfaces of the porous sintered body 1, the entirety of the porous sintered body 1 needs to be completely immersed in the treatment liquid 71. Therefore, it is desirable that the level 71a comes over the upper surface, in the figure, of the porous sintered body 1. In the present invention, as long as the liquid level is higher than the upper surface of the porous sintered body, the position of the liquid level is not limited within the length of the glass tube 41a but may be higher than the glass tube 41a. After the inside of the porous sintered body 1 is sufficiently impregnated with the treatment liquid 71, the intermediate product is pulled out of the treatment liquid 71 and subjected to baking. By repetitively performing the immersion process and the baking process a plurality of times, a solid electrolytic layer 30 of manganese dioxide is formed on the dielectric layer, as shown in FIG. 6. Specifically, the solid electrolytic layer 30 of manganese dioxide is formed on the dielectric layer on the inner and the outer surfaces of the porous sintered body 1 and the dielectric layer on the anode bars 2A, 2B which contacts the treatment liquid 71.

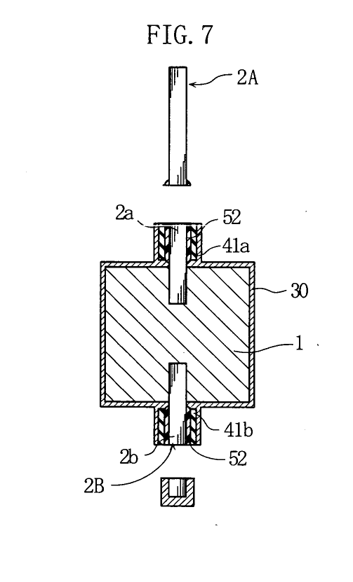

Then, the anode bars 2A and 2B are cut, as shown in FIG. 7. By cutting the anode bars 2A and 2B at predetermined positions spaced from the porous sintered body 1, the length of each of the anode bars 2A and 2B is adjusted to a length suitable for bonding to an external connection member of the solid electrolytic capacitor, which will be described later. Although the anode bars 2a and 2b are cut at positions close to the ends of the glass tubes 41a and 41b in this embodiment, the cutting positions are not limited to these. For instance, the cutting positions may be close to the middle positions of the glass tubes 41a, 41b.

Subsequently, as shown in FIG. 8, the glass tubes 41a, 41b and the bonding resin 52 are removed. The removal may be performed by a so-called lift-off technique which is often employed in forming a wiring pattern on a substrate, for example. According to the lift-off technique, by dissolving and removing the bonding resin 52 by the action of a predetermined solvent, the solid electrolytic layer formed on the glass tubes 41a and 41b can also be removed together with the glass tubes 41a and 41b.

The enlarged view of FIG. 8 schematically shows the micro-structure of a portion which is close to the outer surface of the porous sintered body 1 and close to the anode bar 2A. As shown in the enlarged view, the porous sintered body 1 is formed by the agglomeration of a large number of minute particles 11 of niobium. The dielectric layer 10 is formed on the surfaces of a large number of minute particles 11, the surface of the anode bar 2A, and the surface of the anode bar 2B which is not shown in the enlarged view. The solid electrolytic layer 30 is so formed as to fill the space existing in the porous sintered body 1 after the dielectric layer 10 is formed. The dielectric layer 10 is formed also at part of the surface portion of the anode bar 2A which has been covered by the glass tube 41a and at part of the surface portion of the non-illustrated anode bar 2B which has been covered by the glass tube 41b. This is because, in the dielectric layer formation step described with reference to FIG. 4, the treatment liquid enters to some degree between the anode bar 2A and the glass tube 41a and between the anode bar 2B and the glass tube 41b. The solid electrolytic layer 30 is not formed on the anode bar 2A and the non-illustrated anode bar 2B. Of the dielectric layer 10, the portion contacting the solid electrolytic layer 30 functions as a dielectric of the capacitor. In the intermediate product shown in FIG. 8, the anode bar 2A and the anode bar 2B are electrically connected to each other via the sintered and agglomerated minute particles 11, the dielectric layer 10 is formed mainly on the surfaces of the minute particles 11, and the solid electrolytic layer 30 is formed on the dielectric layer 10.

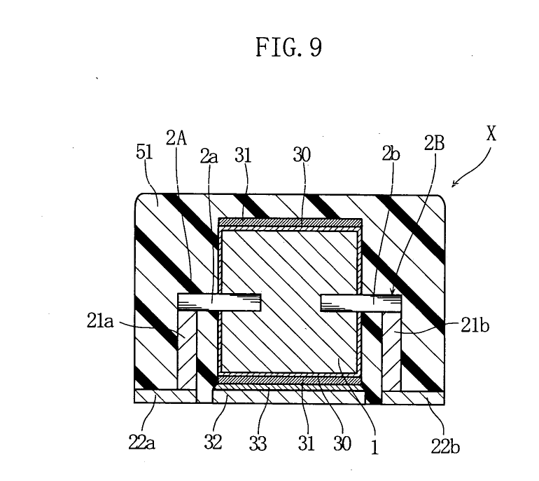

After the above-described removal step, other parts are formed, whereby a solid electrolytic capacitor X as shown in FIG. 9 is completed. Specifically, an anode terminal 22a is electrically connected to the projecting portion 2a of the anode bar 2A via a conductive portion 21a, whereas an anode terminal 22b is electrically connected to the projecting portion 2b of the anode bar 2B via a conductive portion 21b. A conductive film 31 made up of e.g. a graphite layer and a silver layer is formed on a predetermined portion of the solid electrolytic layer 31 on the porous sintered body 1. The conductive film 31 and a cathode terminal 32 are bonded together via a conductive film 33 formed by using a conductive paste. Then, a sealing resin member 51 is provided to seal the entirety while exposing the anode terminals 22a, 22b and the cathode terminal 32. The solid electrolytic capacitor X is a so-called three-terminal solid electrolytic capacitor provided with the anode terminals 22a, 22b and the cathode terminal 32.

In the above-described manufacturing method, the position of an end of the dielectric layer on the projecting portion 2a is set appropriately in the dielectric layer formation step described with reference to FIG. 4, while the position of the glass tube 41a on the projecting portion 2a is set appropriately in the covering step described with reference to FIGS. 2 and 3. By this setting, after both of the dielectric layer formation step and the covering step, the end of the dielectric layer on the projecting portion 2a is positioned farther from the porous sintered body 1 than the end of the glass tube 41a which is closer to the porous sintered body 1 is. That is, in the solid electrolytic layer formation step, the obverse surface of a portion of the anode bar 2A which is between the porous sintered body 1 and the glass tube 41a can be prevented from being exposed. Further, in the above-described manufacturing method, part of the projecting portion 2a of the anode bar 2A is covered by the glass tube 41a before the solid electrolytic layer formation step, and this part does not come into contact with the solid electrolytic layer 30 formed in the solid electrolytic layer formation step. Therefore, in the solid electrolytic capacitor X manufactured by the above-described manufacturing method, the anode bar 2A and the solid electrolytic layer 30 are prevented from unduly coming into -contact with each other. Even when the solid electrolytic layer is formed, in the solid electrolytic layer formation step, on an end of the projecting portion 2a which is not formed with the dielectric layer (in this case, the anode bar 2A and the solid electrolytic layer 30 come into direct contact with each other at the end), the end can be removed by cutting the anode bar 2A in the cutting step described with reference to FIG. 7. Therefore, according to the manufacturing method, even when the solid electrolytic layer 30 is formed, in the solid electrolytic layer formation step, on an end of the projecting portion 2a which is not formed with the dielectric layer, undesirable contact between the anode bar 2A and the solid electrolytic layer 30 is prevented in the obtained solid electrolytic capacitor X.

In the dielectric layer formation step described with reference to FIG. 4, the dielectric layer is formed also at a portion of the anode bar 2b which is not covered by the glass tube 41b and the bonding resin 52. Therefore, in the solid electrolytic layer formation step, the solid electrolytic layer 30 which directly comes into contact with the obverse surface of the anode bar 2B is not formed. By the cutting step described with reference to FIG. 7 and the removal step described with reference to FIG. 8, part of the obverse surface of the anode bar 2B can be exposed, and the above-described terminal 21b can be properly connected to the exposed part. In this way, in the solid electrolytic capacitor X manufactured by the above-described manufacturing method, the anode bar 2B electrically connected to the terminal 21b and the solid electrolytic layer 30 are prevented from unduly coming into contact with each other.

Therefore, according to the above-described manufacturing method, it is possible to properly manufacture a solid electrolytic capacitor X provided with a plurality of anode bars 2a and 2b projecting from different surfaces of the porous sintered body 1. (With the conventional manufacturing method described before, it is not possible to manufacture a solid electrolytic capacitor provided with anode bars projecting from different surfaces of the porous sintered body.) In using the solid electrolytic capacitor X, current can be caused to flow dispersedly through two anode bars 2a, 2b. Therefore, the solid electrolytic capacitor X is suitable for reducing the resistance and the inductance.

According to the above-described manufacturing method, a solid electrolytic capacitor X which does not include glass tubes 41a and 41b can be manufactured. Therefore, the solid electrolytic capacitor X does not require the space for the glass tubes 41a and 41b. Therefore, the solid electrolytic capacitor X is suitable for size reduction.

In the above-described manufacturing method, by increasing the length of the glass tube 41a in the direction in which the anode bar 2A extends, it is possible to increase the allowable range of the height of the intermediate product relative to the level 71a of the treatment liquid 71 in the solid electrolytic layer formation step. Further, by reducing the thickness of the glass tube 41a and 41b, the area of the porous sintered body 1 which is covered by the glass tubes 41a and 41b can be reduced, which is advantageous for promoting the infiltration of the treatment liquid 61 into the porous sintered body 1 in the dielectric layer formation step and the infiltration of the treatment liquid 71 into the porous sintered body 1 in the solid electrolytic layer formation step.

According to the above-described manufacturing method, by cutting the anode bars 2A and 2B to predetermined length after the formation of the solid electrolytic layer 30, the length of the anode bars 2A and 2B can be adjusted to be suitable for the connection to the terminals 21a and 21b.

Since the glass tubes 41a and 41b used in the manufacturing method are excellent in acid resistance and corrosion resistance, the glass tubes are not easily corroded by the treatment liquid 61, 71 in the dielectric layer formation step and the solid electrolytic layer formation step. Therefore, the anode bars 2A and 2B are prevented from being unduly exposed in the dielectric layer formation step and the solid electrolytic layer formation step.

In the present invention, instead of fitting and bonding the glass tube 41a to the projecting portion 2a of the anode bar 2A before the dielectric layer formation step, the fitting and bonding the glass tube 41a to the projecting portion 2a may be performed after the dielectric layer formation step and before the solid electrolytic layer formation step. In this case, the glass tube 41a is fitted to the projecting portion 2a in such a manner that the end of the dielectric layer on the projecting portion 2a is positioned within the length of the glass tube 41a and closer to the porous sintered body 1. With this alternative technique, the dielectric layer can be formed reliably at a predetermined part of the projecting portion 2a which is adjacent to the porous sintered body 1. Therefore, this alternative method is advantageous for preventing the anode bar 2A and the solid electrolytic layer 30 from unduly coming into contact with each other. Further, the fitting and bonding of the glass tube 41a to the projecting portion 2a after the dielectric layer formation step is preferable for causing the treatment liquid 61 to sufficiently infiltrate into the porous sintered body 1 at a portion adjacent to the anode bar 2A in the dielectric layer formation step. Even when this alternative method is employed, the conductive portion 21a can be connected to the portion of the anode bar 2A at which the dielectric layer is not formed.

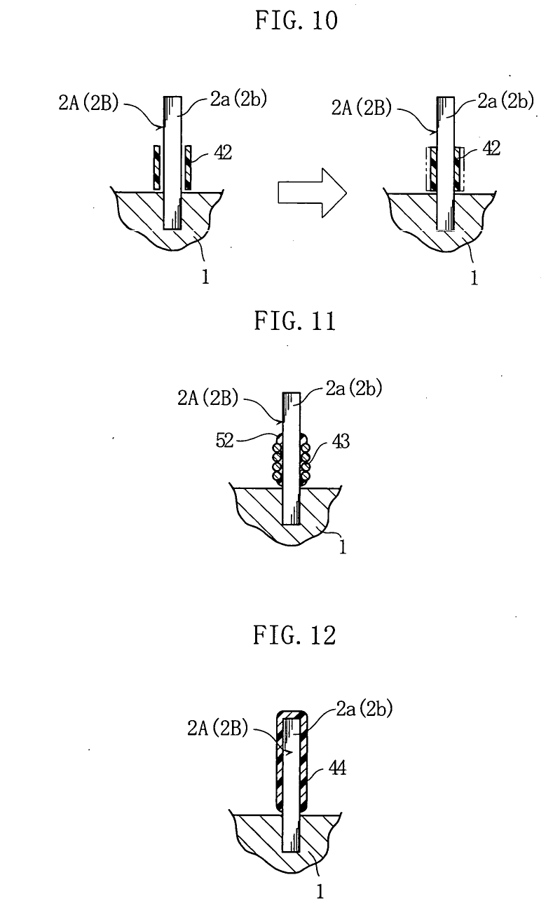

In the present invention, instead of the covering step described with reference to FIGS. 2 and 3, the covering steps shown in FIGS. 10-13, 14, and 17 may be employed.

In the covering step shown in FIG. 10, as shown in the left side in the figure, a resin pipe 42 made of resin having a heat shrinkability is fitted to each of the projecting portions 2a and 2b. The inner diameter of the resin pipe 42 is larger than the diameter of the anode bar 2A, 2B. Thereafter, the resin pipe 42 is heated to a predetermined temperature for shrinkage, whereby the resin pipe 42 is closely fitted to the anode bar 2A, 2B, as shown in the right side of the figure. This covering step is suitable for simplifying the manufacturing process.

In the covering step shown in FIG. 11, after bonding resin 52 is applied to a predetermined part of each of the projecting portions 2a and 2b, a metal wire 43 is helically wound around the part to which the resin is applied. Instead of the metal wire 43, a linear member made of resin may be wound around. With this technique again, the covering member of the present invention can be mounted to the anode bars 2A and 2B or the projecting portions 2a and 2b. The metal wire 43 and the linear resin member can be easily removed from the projecting portions 2a and 2b by turning it in a direction opposite from the winding direction while holding one end thereof.

In the covering step shown in FIG. 12, a resin cover 44 is provided to cover each of the projecting portions 2a and 2b generally entirely. As the material of the resin cover 44, it is preferable to use a resin having excellent acid resistance and corrosion resistance. In the case where this covering step is employed, even when the projecting portions 2a and 2b are entirely immersed in the treatment liquid 71 in the solid electrolytic layer formation step, the entirety of the projecting portions 2a and 2b can be exposed by removing the resin cover 44 in the removal step. Further, in the case where the covering step shown in FIG. 12 is employed, the anode bars 2A and 2B do not necessarily need to be cut in the process of manufacturing the solid electrolytic capacitor.

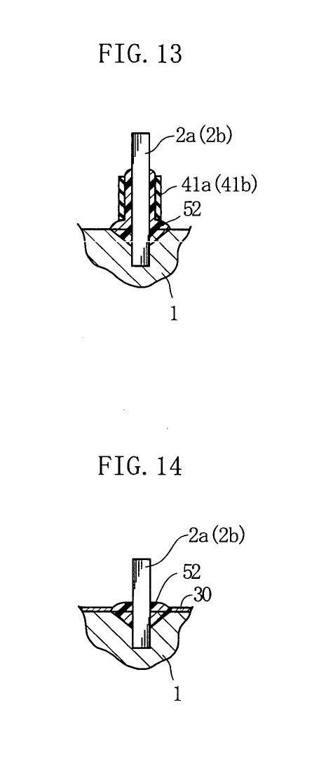

In the covering step shown in FIG. 13, bonding resin 52 is applied along the anode bars 2a and 2b so as to partially enter the porous sintered body 1. In this state, glass tubes 41a and 41b are fitted and bonded to the projecting portions 2a and 2b. When this covering step is employed, as shown in FIG. 14, the bonding resin 52 remains after the dielectric layer formation step, the solid electrolytic layer formation step, the cutting step and the removal step are performed. This bonding resin provides insulation between the projecting portion 2a, 2b and the solid electrolytic layer 30. Further, the strength of the portion where the anode bar 2A, 2B and the porous sintered body 1 are bonded together can be increased. Therefore, by employing the covering step shown in FIG. 13, it is possible to prevent the porous sintered body 1 from cracking and the anode bars 2A and 2B from easily separating from the porous sintered body 1 even when a moment is applied to the anode bar 2A, 2B, for example.

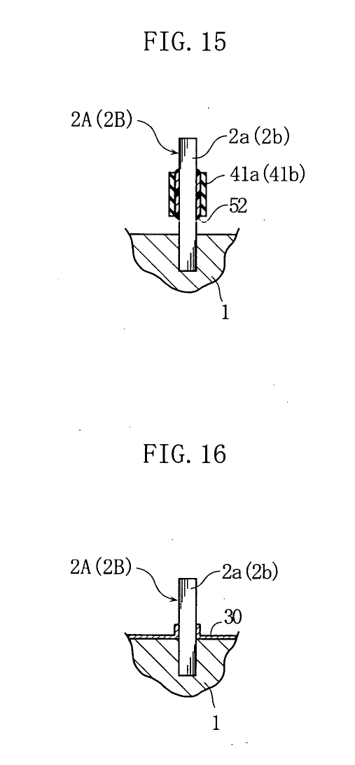

In the covering step shown in FIG. 15, a significant gap is defined between the glass tube 41a, 41b or the bonding resin 52 and the porous sintered body 1. When this covering step is employed, as shown in FIG. 16, in the state after the dielectric layer formation step, the solid electrolytic layer formation step, the cutting step and the removal step are performed, the solid electrolytic layer 30 exists at a root portion of the projecting portion 2a, 2b projecting from the porous sintered body 1. Therefore, similarly to the covering step shown in FIG. 13, the covering step shown in FIG. 15 can also enhance the strength of the portion where the anode bar 2A, 2B and the porous sintered body 1 are bonded together.

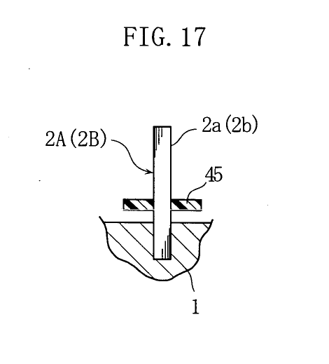

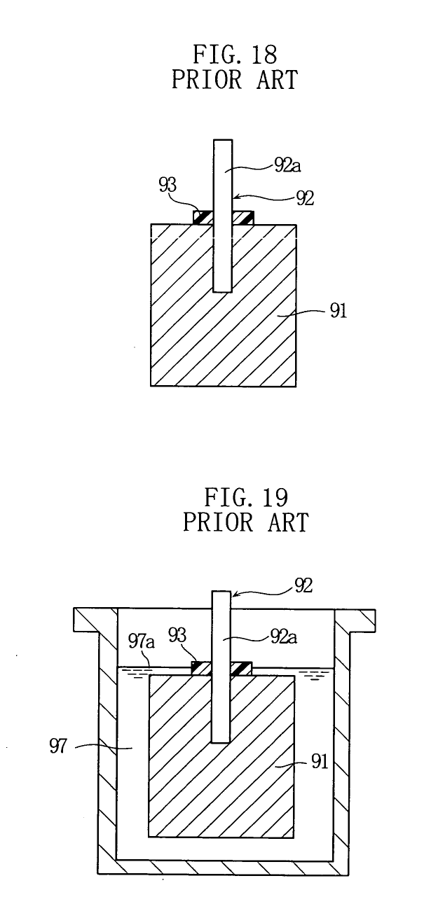

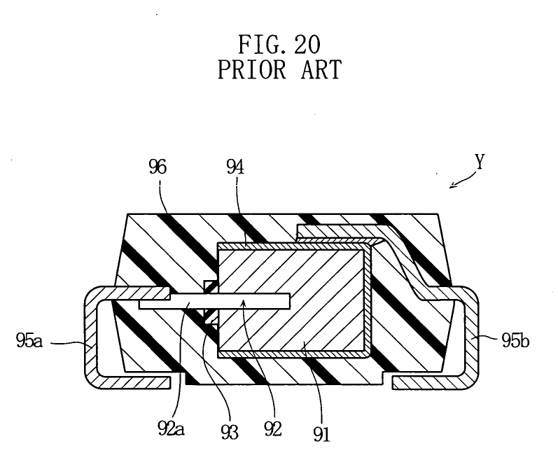

In the covering step shown in FIG. 17, a flat ring 45 having a water repellency is fixed to each of the projecting portions 2a and 2b at a position which is significantly spaced from the porous sintered body 1. When this covering step is employed, in the state after the dielectric layer formation step, the solid electrolytic layer formation step, the cutting step and the removal step are performed, the solid electrolytic layer 30 exists at a root portion of the projecting portion 2a, 2b projecting from the porous sintered body 1, similarly to the case where the covering step shown in FIG. 15 is employed. Therefore, similarly to the covering steps shown in FIGS. 13 and 15, the covering step shown in FIG. 17 can also enhance the strength of the portion where the anode bar 2A, 2B and the porous sintered body 1 are bonded together.

1. A method for manufacturing a solid electrolytic capacitor, the method comprising:
a dielectric layer formation step for forming a dielectric layer at an inner surface and an outer surface of a porous sintered body to which an anode bar is fixed, the anode bar including a projecting portion projecting from the porous sintered body;
a solid electrolytic layer formation step for forming a solid electrolytic layer on the dielectric layer;
a covering step for covering at least part of the projecting portion of the anode bar by a covering member, the covering step being performed before the solid electrolytic layer formation step; and
a removal step for removing at least part of the covering member, the removal step being performed after the solid electrolytic layer formation step.

2. The solid electrolytic capacitor manufacturing method according to claim 1, wherein the covering step is performed before the dielectric layer formation step.

3. The solid electrolytic capacitor manufacturing method according to claim 1, wherein the covering step is performed after the dielectric layer formation step.

4. The solid electrolytic capacitor manufacturing method according to claim 1, further comprising the step of cutting the anode bar at a position spaced from the porous sintered body, the cutting step being performed after the solid electrolytic layer formation step.

5. The solid electrolytic capacitor manufacturing method according to claim 1, further comprising the step of cutting the anode bar at a position covered by the covering member, the cutting step being performed after the solid electrolytic layer formation step.

6. The solid electrolytic capacitor manufacturing method according to claim 1, wherein an additional anode bar is fixed to the porous sintered body, the additional anode bar including a projecting portion projecting from the porous sintered body;
wherein the dielectric layer formation step comprises immersing the projecting portion of the additional anode bar entirely in a treatment liquid for forming the dielectric layer;
wherein the covering step comprises covering at least part of the projecting portion of the additional anode bar by an additional covering member;
wherein the solid electrolytic layer formation step comprises immersing the projecting portion of the additional anode bar entirely in a treatment liquid for forming the solid electrolytic layer; and
wherein the removal step comprises removing at least part of the additional covering member.

7. The solid electrolytic capacitor manufacturing method according to claim 1, wherein, in a state in which the covering member covers the anode bar, the covering member has a cylindrical configuration extending in a direction in which the anode bar extends.

8. The solid electrolytic capacitor manufacturing method according to claim 1, wherein the covering member comprises a glass tube, and the covering step comprises fitting the glass tube around the anode bar.

9. The solid electrolytic capacitor manufacturing method according to claim 1, wherein the covering member comprises a metal wire, and the covering step comprises winding the metal wire around the anode bar.

10. The solid electrolytic capacitor manufacturing method according to claim 1, wherein the covering member comprises a linear member made of resin, and the covering step comprises winding the linear member around the anode bar.

11. The solid electrolytic capacitor manufacturing method according to claim 1, wherein the covering step comprises bonding the covering member to the anode bar with a bonding material.

12. The solid electrolytic capacitor manufacturing method according to claim 1, wherein the covering member comprises a tubular member made of resin having a heat shrinkability, and the covering step comprises fitting the tubular member around the anode bar.
